(19) United States
(12) Patent Application Publication
(10) Pub. No.: US 2012/0241506 A1
(43) Pub. Date: Sep. 27, 2012

(54) Concave Solder Tip

(75) Inventors: Charles M. Gross, Etters, PA (US); Joshua A. Garman, Mount Holly Springs, PA (US)

(73) Assignee: FCI Americas Technology LLC

(21) Appl. No.: 13/399,131

(22) Filed: Feb. 17, 2012

Related U.S. Application Data
(60) Provisional application No. 61/467,149, filed on Mar. 24, 2011.

(51) Int. Cl. B23K 31/02; B23K 3/02

(52) U.S. Cl. 228/180.5; 228/54

(57) ABSTRACT

A solder tip having a bottom end. The bottom end includes a concave channel between a front side of the bottom end and a back side of the bottom end. The concave channel has a substantially uniform cross-sectional shape.

### CROSS REFERENCE TO RELATED APPLICATION

This application claims priority under 35 USC 119(e) upon Provisional Patent Application No. 61/467,149, filed Mar. 24, 2011, which is hereby incorporated by reference in its entirety.

### BACKGROUND

1. Technical Field

The exemplary and non-limiting embodiments of the invention relate generally to soldering and, more particularly, to a soldering tip.

2. Brief Description of Prior Developments

U.S. Pat. No. 5,332,144 describes a concave soldering iron tip. U.S. Pat. No. 3,580,462 discloses a soldering tip with slots.

### SUMMARY

The following summary is merely intended to be exemplary. The summary is not intended to limit the scope of the claims.

In accordance with one aspect, a solder tip is provided having a bottom end. The bottom end includes a concave channel between a front side of the bottom end and a back side of the bottom end. The concave channel has a substantially uniform cross-sectional shape.

In accordance with another aspect, a solder tip is provided comprising a bottom surface. The bottom surface includes a wire aligner configured to align a wire to be soldered at a position on the bottom surface of the solder tip. The wire aligner comprises a concave channel between front and rear sides of the bottom surface. The concave channel is sized and shaped to receive the wire to be soldered in the concave channel such that an area of contact between the wire and the bottom surface at the channel has a longitudinal length and a curved cross-sectional shape along the longitudinal length.

In accordance with another aspect, a method comprises providing a solder tip where the solder tip comprises a bottom end having a concave channel between a front side of the bottom end and a back side of the bottom end; pressing a wire by the solder tip against a substrate, where the wire is at least partially received in the concave channel, where an area of contact between the wire and the bottom end at the channel has a longitudinal length and a curved cross-sectional shape along the longitudinal length, and where opposite left and right sides of the bottom end extend below a top side of the wire; and providing heat from the solder tip to the wire and the substrate.

### BRIEF DESCRIPTION OF THE DRAWINGS

The foregoing aspects and other features are explained in the following description, taken in connection with the accompanying drawings, wherein:

FIG. 1 is a front view of a solder tip being used to solder a wire to a substrate;

FIG. 2 is a left side view of the components shown in FIG. 1;

FIG. 3 is an enlarged front view of the solder tip shown in FIGS. 1-2;

FIG. 4 is a diagram illustrating an apparatus comprising the solder tip shown in FIGS. 1-3;

FIG. 5 is a perspective view of the solder tip shown in FIGS. 1-3 being used to solder a smaller size wire to the substrate; and

FIG. 6 is an enlarged front side view of the wire and solder tip shown in FIG. 5.

### DETAILED DESCRIPTION OF EMBODIMENT

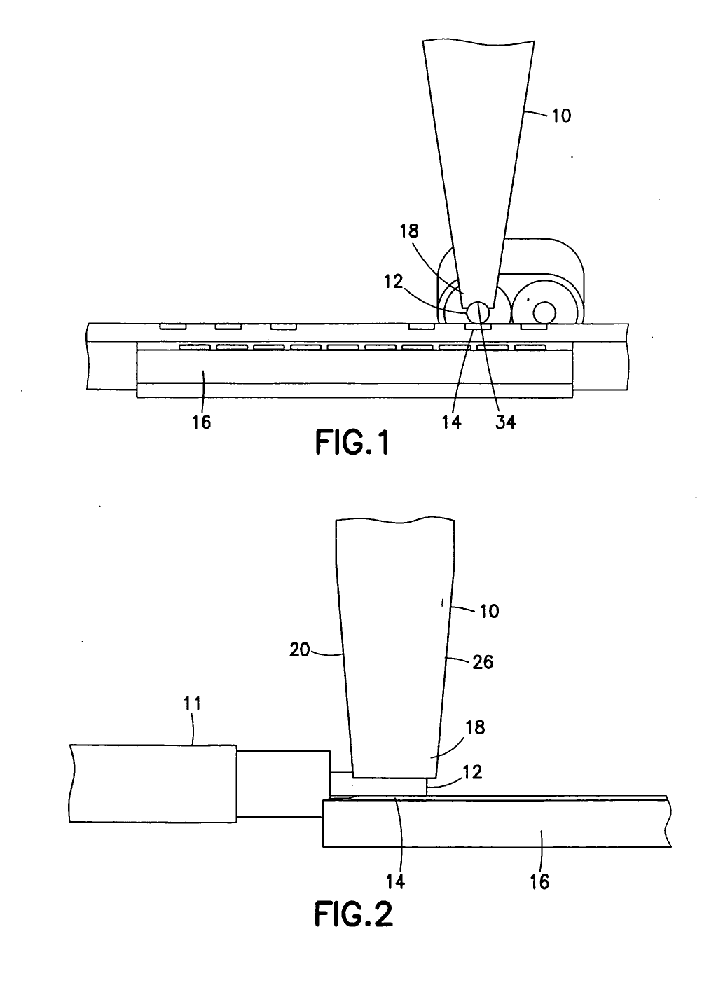

Referring to FIG. 1, there is shown a front side view of a solder tip or bit 10 incorporating features of an example embodiment. Although features will be described with reference to the example embodiment shown in the drawings, it should be understood that features can be embodied in many alternate forms of embodiments. In addition, any suitable size, shape or type of elements or materials could be used.

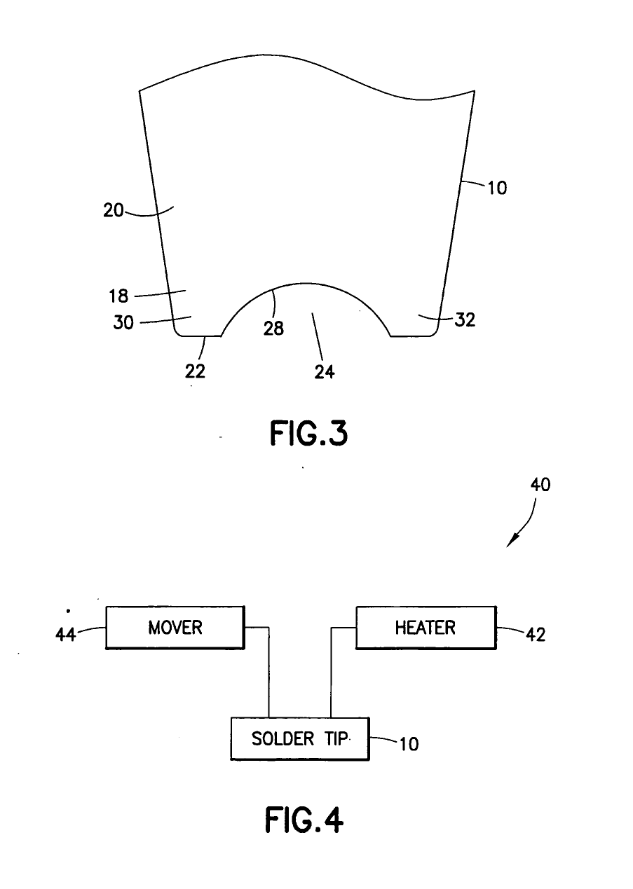

Referring also to FIG. 2, the solder tip 10 is shown locating an electrical conductor wire 12 of a cable 11 against a contact area 14 of a substrate 16, such as a printed wiring board for example. FIG. 3 shows an enlarged view at the front side 20 of the bottom end 18 of the tip 10. The bottom end 18 has a bottom surface 22 comprising a concave channel 24. The channel 24 extends between the front side 20 and the opposite back side 26. The channel 24 has a curved surface 28 between left and right side portions 30, 32. The concave channel 24 has a substantially uniform cross-sectional shape between the front and back sides 20, 26. However, in an alternate embodiment the cross-sectional shape might not be uniform. For example, the surface 28 could have gripping protrusions to grip onto the wire 12, or rib protrusions or recessed. In addition, the channel 24 might not extend entirely to the exterior of the back side.

The concave channel 24 is sized and shaped to receive the wire 12 to be soldered in the concave channel such that an area of contact 34 between the wire 12 and the bottom end in the channel 24 has a longitudinal length and a curved cross-sectional shape along the longitudinal length. Thus, the curved surface 28 allows for a larger area of contact between the wire 12 and the tip 10 for better heat transfer. As seen in FIGS. 1 and 2, because of the shape of the bottom end 18, the left and right side portions 30, 32 are able to extend downward past the top side of the wire. Thus, the left and right side portions 30, 32 also allow heat to be transferred to left and right sides to the wire 12 rather than merely downward from the top of the wire.

The configuration provided by the shape of the bottom end 20 not only provides enhanced heat transfer to the wire 12, but also provides enhanced heat transfer to the substrate 16 at the contact area 14. The contact area may comprise solder to reflow onto the wire 12, and/or additional solder could be added. Because of the shape of the bottom end 20, when the wire 12 is located in the channel 24, and the solder tip 10 presses the wire 12 against the substrate contact area 14, portions of the tip 10 are located closer to the substrate contact area 14 past the top side of the wire 12. In particular, the left side and right side portions 30, 32 extend past the top side of the wire 12 to be located closer to the substrate. Thus, heat transfer from the bottom surface 22 to the substrate contact area 14 is increased because the distance between the bottom surface 22 (at the left side and right side portions 30, 32) to the substrate contact area 14 is less than the height of the wire 12.

Referring also to FIG. 4, the solder tip 10 is shown as part of an apparatus 40 which comprises a heater and a mover 44. The heater 42 may be at least partially integrated with the tip 10. The mover 44 may comprise a computer controlled robotic mover to move the tip 10 to a desired location. Alternatively, the solder tip 10 can be provided on a hand-held soldering apparatus or soldering iron.

In addition to the enhanced heat transfer configuration provided by the shape of the bottom end 20, the channel 24 also provides a second feature. The tip 10 has a wire aligner configured to align the wire 12 to at a position on the bottom surface 22 of the solder tip 10. The aligner comprises the concave channel 24 between front and rear sides 20, 26 of the bottom surface. In particular, because of the shape of the channel 24 and the general circular cross section of the wire, as the tip 10 presses the wire 12 against the substrate contact area 14, the wire 12 is aligned by the curved surface 28 in the channel 24. The channel 24 acts as a seat or pocket for the wire 12. This can be used to more precisely align the wire 12 onto the substrate 16.

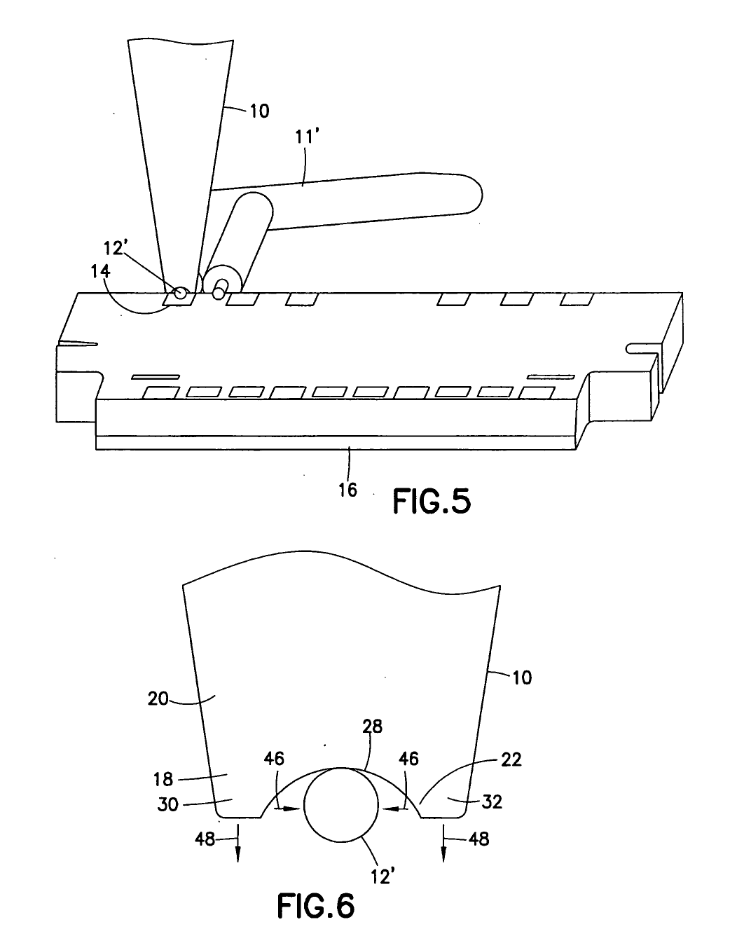

FIGS. 1-2 show an example of where the curvature of the outer perimeter of the wire 12 substantially matches curvature of the surface 28. Referring also to FIG. 5, the solder tip 10 and substrate are shown with a cable 11′ having smaller diameter wires 12′. Referring also to FIG. 6, even though the area of direct contact between the wire 12′ and surface 28 is not as large as with the larger diameter wire 12, because the left and right side portions 30, 32 extend past the top side of the wire 12′ and along portions of the left and right sides of the wire 12′, heat transfer is enhanced because of the heat transferred inward as indicated generally by arrows 46. The bottom surface 22 at the left and right side portions 30, 32 also transfer heat to the contact area 14 as illustrated by arrows 48 in FIG. 6.

Again, in addition to the enhanced heat transfer configuration provided by the shape of the bottom end 20, the channel 24 also provides a wire aligner configured to align the wire 12′ to at a position on the bottom surface 22 of the solder tip 10. The aligner comprises the concave channel 24. In particular, because of the shape of the channel 24 and the general circular cross section of the wire 12′, as the tip 10 presses the wire 12′ against the substrate contact area 14, the wire 12′ is aligned by the curved surface 28 in the channel 24. The channel 24 acts as a seat or pocket for the wire 12′. This can be used to more precisely align the wire 12′ onto the substrate 16. The shape of the channel 24 can function as an automatic centering system to center the wire relative to the solder tip. As seen by comparing the different size wires shown in FIGS. 1 and 6, the wire aligner is range taking. In other words, the same solder tip can be used with a range of different size wires and still provide the alignment/centering feature.

The solder tip may be used in a soldering machine/robot. In the example embodiment the tip has a concave surface at the wire interface. In the example embodiment tip is primarily used for attaching wires to PCBs, wherein the PCBs are subsequently incorporated into a cable assembly plug, such as an optical transceiver for example. In the past, solder machines/robots have been having a problem soldering small wires in a reliable manner. The example embodiment solves the consistency problem such that a small wire may be located at a predetermined location on a substrate (or other item) by the solder tip more consistently and with less wire locating errors or problems.

An example embodiment may comprise a solder tip comprising a bottom end, where the bottom end includes a concave channel between a front side of the bottom end and a back side of the bottom end, where the concave channel comprises a substantially uniform cross-sectional shape.

The bottom end may comprise a curved surface in the channel between left side and right side portions of the bottom end. The substantially uniform cross-sectional shape of the channel may have a curved top side. The concave channel may be sized and shaped to receive a wire to be soldered in the concave channel such that an area of contact between the wire and the bottom end in the channel has a longitudinal length and a curved cross-sectional shape along the longitudinal length. The bottom end may be shaped such that, when a wire to be solder is in the concave channel, opposite left and right sides of the bottom end extend below a top side of the wire. The solder tip may comprise means for aligning a wire to be soldered at a position on the bottom end of the solder tip, where the means for aligning comprises the concave channel. An apparatus may comprising a solder tip as described above; and means for heating the solder tip.

In an example embodiment a solder tip may comprise a bottom surface, where the bottom surface includes a wire aligner configured to align a wire to be soldered at a position on the bottom surface of the solder tip, where the wire aligner comprises a concave channel between front and rear sides of the bottom surface, where the concave channel is sized and shaped to receive the wire to be soldered in the concave channel such that an area of contact between the wire and the bottom surface at the channel has a longitudinal length and a curved cross-sectional shape along the longitudinal length.

The concave channel may comprise a substantially uniform cross-sectional shape. The substantially uniform cross-sectional shape of the channel may be curved. The bottom surface may comprise a curved portion in the channel between left and right sides of the bottom surface. The bottom surface may shaped such that, when the wire to be solder is in the concave channel, opposite left and right sides of the bottom surface extend below a top side of the wire.

One example method comprises providing a solder tip where the solder tip comprises a bottom end having a concave channel between a front side of the bottom end and a back side of the bottom end; pressing a wire by the solder tip against a substrate, where the wire is at least partially received in the concave channel, where an area of contact between the wire and the bottom end at the channel has a longitudinal length and a curved cross-sectional shape along the longitudinal length, and where opposite left and right sides of the bottom end extend below a top side of the wire; and providing heat from the solder tip to the wire and the substrate.

The method may further comprise aligning the wire on the bottom end by the concave channel. Providing the solder tip may comprise the concave channel having a substantially uniform cross-sectional shape. Providing the solder tip may comprise the bottom end comprising a curved surface in the channel between left side and right side portions of the bottom end.

For a Solder Tip Construction/Composition, in one type of example embodiment, over-all plating except working area is “black chromium” which prevents solder migration into undesired areas of tip. Beneath the black chromium plating there is a pure iron plating that aids the adhesion of the black chromium. The working area plating is “tin” which assists transfer of molten solder to solder target (wire/solder pad). The inter core of the solder tip consists of “oxygen free copper” which stabilizes heat within the tip. The base material is a steel alloy that will accommodate high temperatures for extended periods, and stainless steel is sometimes used and is application dependent.

For a conventional Ultrasonic Tip Construction/Composition, on the other hand, the overall plating is chrome; such as polished to a mirror finish to prevent marking of materials being bonded (when appearance is of no concern, a mirror finished is not used; however chrome is still used). Beneath the chrome plating there is a nickel plating that aids the adhesion of the chrome plating. The working area is typically chrome when bonding materials and stainless steel when welding. The base material is steel alloy such as solid construction with no inter core materials.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A solder tip comprising a bottom end, where the bottom end includes a concave channel between a front side of the bottom end and a back side of the bottom end, where the concave channel comprises a substantially uniform cross-sectional shape.

2. A solder tip as in claim 1 where the bottom end comprises a curved surface in the channel between left side and right side portions of the bottom end.

3. A solder tip as in claim 1 where the substantially uniform cross-sectional shape of the channel has a curved top side.

4. A solder tip as in claim 1 where the concave channel is sized and shaped to receive a wire to be soldered in the concave channel such that an area of contact between the wire and the bottom end in the channel has a longitudinal length and a curved cross-sectional shape along the longitudinal length.

5. A solder tip as in claim 4 where the bottom end is shaped such that, when a wire to be solder is in the concave channel, opposite left and right sides of the bottom end extend below a top side of the wire.

6. A solder tip as in claim 1 comprising means for aligning a wire to be soldered at a position on the bottom end of the solder tip, where the means for aligning comprises the concave channel.

7. An apparatus comprising:
a solder tip as in claim 1; and
means for heating the solder tip.

8. A solder tip comprising a bottom surface, where the bottom surface includes a wire aligner configured to align a wire to be soldered at a position on the bottom surface of the solder tip, where the wire aligner comprises a concave channel between front and rear sides of the bottom surface, where the concave channel is sized and shaped to receive the wire to be soldered in the concave channel such that an area of contact between the wire and the bottom surface at the channel has a longitudinal length and a curved cross-sectional shape along the longitudinal length.

9. A solder tip as in claim 8 where the concave channel comprises a substantially uniform cross-sectional shape.

10. A solder tip as in claim 9 where the substantially uniform cross-sectional shape of the channel is curved.

11. A solder tip as in claim 8 where the bottom surface comprises a curved portion in the channel between left and right sides of the bottom surface.

12. A solder tip as in claim 8 where the bottom surface is shaped such that, when the wire to be solder is in the concave channel, opposite left and right sides of the bottom surface extend below a top side of the wire.

13. A method comprising:
providing a solder tip where the solder tip comprises a bottom end having a concave channel between a front side of the bottom end and a back side of the bottom end;
pressing a wire by the solder tip against a substrate, where the wire is at least partially received in the concave channel, where an area of contact between the wire and the bottom end at the channel has a longitudinal length and a curved cross-sectional shape along the longitudinal length, and where opposite left and right sides of the bottom end extend below a top side of the wire; and
providing heat from the solder tip to the wire and the substrate.

14. A method as in claim 13 further comprising aligning the wire on the bottom end by the concave channel.

15. A method as in claim 13 where providing the solder tip comprises the concave channel having a substantially uniform cross-sectional shape.

16. A method as in claim 13 where providing the solder tip comprises the bottom end comprising a curved surface in the channel between left side and right side portions of the bottom end.
